(19) United States
(12) Patent Application Publication
(10) Pub. No.: US 2013/0249711 A1
(43) Pub. Date: Sep. 26, 2013

(54) Method, System, Apparatus to determine and manage parking space(s) availability in a parking lot using electro-piezo bumps

(71) Applicant: Lalitha Vellore Sripathi Rao, Santa Clara, CA (US)

(72) Inventor: Lalitha Vellore Sripathi Rao, Santa Clara, CA (US)

(21) Appl. No.: 13/430,339

(22) Filed: Mar. 26, 2012

(51) Int. Cl. G08G 1/14

(52) U.S. Cl. 340/932.2

(57) ABSTRACT

The current invention is a method, system, apparatus to determine which spaces in a parking lot are available and communicate this to end users looking to park. This method uses sensors designed based on the electromagnetic piezoelectric framework described in U.S. patent application Ser. No. 13/197,776. These sensors, henceforth referred to as electro-piezo sensors, use electromagnetic and piezoelectric mechanisms to convert the stress and vibration from the motion of vehicles into electric signals. These electric signals are routed to a decision engine that has inbuilt intelligence to interpret them, manage the parking space availability and interface with any peripheral systems to show the space availability in a parking lot. An example of a peripheral system is a mobile device that tells a driver which specific spaces are available and allows them to reserve a space to park their car as they drive into the parking lot.

### BACKGROUND OF INVENTION

In today's world, we spend lot of time driving in parking lots searching for an available space to park. In many instances, time and effort is wasted without getting a parking space or facing off against others also looking to park. We need a method, system, apparatus to efficiently display parking space(s) availability and allow people to reserve and park in them. End users of this system can be drivers in vehicles or people from any location (eg: work, home). These end users will be able to see which parking spaces are available in a parking lot via their user interface and reserve it for their use. Applications can be built using this method, system, apparatus that allow end users to view parking space(s) availability and manage their reservations for current or future use. Potential features of such applications include, but are not limited to,
Users can specify time (i.e. right now or for a future time) and the duration for the parking space reservation.
Users can modify and/or cancel their reservations.
Users can make multiple reservations.
Users can make reservations through their desktop, laptop, smart phone, tablet and other devices.
Application can integrate with users' navigation systems to provide directions to their parking space.
Parking lot administrators/managers can make new spaces available, existing spaces unavailable, set tiered reservation policies (i.e. pay more for better spaces within a parking lot) etc.
End users can be billed depending on the timestamp of entry and exit of parking space

### DETAILED DESCRIPTION OF INVENTION

FIG. 1 shows a block diagram of parking lot management framework. Parking spaces in a parking lot, each with electro-piezo bump incorporating electro-piezo sensors, generate electrical signals and send them to the decision engine. The decision engine in turn interfaces with peripheral systems to show available parking spaces to end users and allow them to reserve. The decision engine can be combination of one or more components built using, but not limited to, hardware and software.

FIG. 2 displays snapshot of a parking lot, with the electro-piezo bumps shown on each parking space. Each parking space has an entrance from one side for the vehicles to enter and park. The other side of the parking space has a barrier to prevent vehicles crossing over from other spaces. The sides of the parking spaces also have barriers to preserve the integrity of parking lot, parking spaces and for efficient allocation.

As shown in FIG. 3, each parking space is equipped with a bump embedded with electro-piezo sensors that detect motion and then generate electricity from mechanical stress or vibration of vehicle as indicated in U.S. patent application Ser. No. 13/197,776. The electro-piezo sensors are embedded on either sides of the bump on the leading and trailing edges. Leading edge of the bump is the edge closer to entry point of the parking space. Trailing edge is edge farther away from the entry point of the parking space. The position of the bump in the parking space is not fixed, it can be positioned as the experts designing the parking lot see fit (eg: for different types of vehicles).

The leading edge and trailing edge of the bump send out electric signals at different time stamps when subjected to stress or vibration of vehicle in either direction.

As illustrated in state diagram in FIG. 4, parking space can transition to empty or occupied state depending on the timestamp of electric signals generated by the leading and trailing edges of the bump.

The different scenarios:
If leading edge and trailing edge signals are present and if leading edge signal timestamp<trailing edge signal timestamp then a vehicle just pulled in. So the parking space status changes from empty to occupied.
If leading edge and trailing edge signals are present and if leading edge signal timestamp>trailing edge signal timestamp then a vehicle just pulled out. So the parking space status changes to occupied to empty.
If in empty state and only leading edge signal is detected, parking space remains in empty state.
If in occupied state and only trailing edge signal is detected, parking space remains in occupied state.

The electric signals generated at different time stamps are fed to decision engine. The intelligence in the decision engine has the capability to interpret these electric signals, manage the parking lot and interface with various peripheral systems to convey status of parking lot to end users. End users can reserve/unreserve parking spaces for current or future use using the status. The peripheral systems can be combination of one or more, but not limited to, display devices installed in parking lot, devices integrated with the internet, devices integrated with satellites.

### SUMMARY OF THE INVENTION

For efficient management of spaces in a parking lot, this invention provides a method or system or apparatus to generate electric signals by detecting the motion of vehicles in parking lot and, these electrical signals are processed through a decision engine that provides the status of the parking space(s) availability to end users through a peripheral system. The generation of electricity from stress and vibration of vehicles is based on U.S. patent application Ser. No. 13/197,776. Status of parking spaces can be displayed to end users through various user interface devices depending on the application.

### DESCRIPTION OF DRAWINGS

Drawings are not to scale and are meant for illustrative purposes only to educate knowledgeable experts on how the various components of this invention can be put together.

FIG. 1: Depicts block diagram of parking lot management framework

FIG. 2: Depicts a snap shot of parking lot with electro-piezo bumps embedded into parking spaces

FIG. 3: Describes parking space with bump in greater detail

FIG. 4: Describes state diagram of parking space

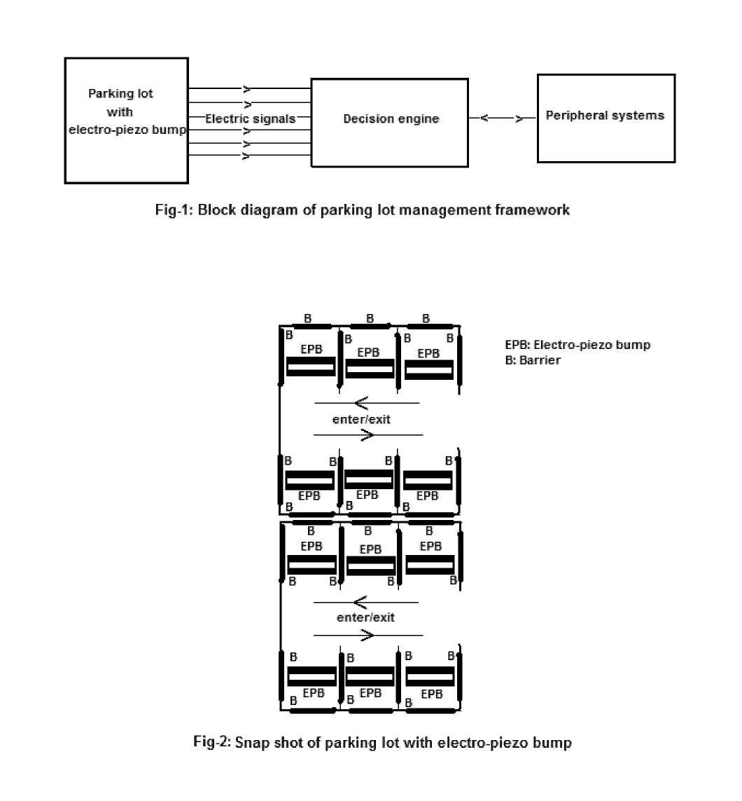

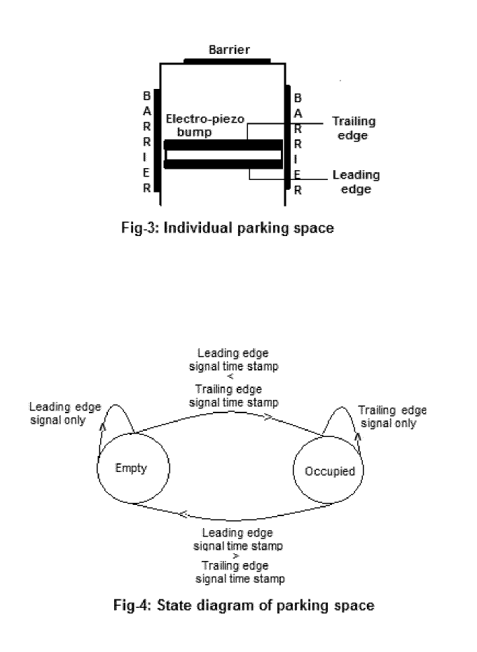

1. This method does not impose any limits on the number of spaces in a parking lot.

2. This method is not limited to the position, shape, size or material of the bump constructed in parking spaces, or the number of energy harvesting electro-piezo sensors that are embedded on the bump's edges to generate electric signals from motion of vehicles.

3. This method is not limited to the design of decision engine which can be combination of one or more components such as, but not limited to, hardware, software.

4. This method is not limited to the count or type of peripheral devices used to convey status of parking space to end users.

5. This method is no limited to any specific design of the vehicle or parking lot and can be customized depending on the application
